(19) United States
(12) Patent Application Publication
(10) Pub. No.: US 2012/0210377 A1
(43) Pub. Date: Aug. 16, 2012

(54) SOCIAL NETWORKING FEEDBACK VIA SECOND DISPLAY SELECTIONS

(75) Inventors: Ling Jun Wong, Escondido, CA (US); Charles McCoy, Coronado, CA (US); True Xiong, San Diego, CA (US)

(73) Assignees: SONY NETWORK ENTERTAINMENT INTERNATIONAL LLC, Los Angeles, CA (US); SONY CORPORATION, Tokyo (JP)

(21) Appl. No.: 13/076,937

(22) Filed: Mar. 31, 2011

Related U.S. Application Data
(60) Provisional application No. 61/441,880, filed on Feb. 11, 2011.

(51) Int. Cl. H04N 7/173; G06F 3/048; G06F 15/16

(52) U.S. Cl. 725/109; 715/738

(57) ABSTRACT

Systems and methods are disclosed for publishing data to one or more social networking services in which data pertaining to the user's behavior in browsing, selecting, and playing media, from particular sources on a particular IPTV platform, is tracked so that a feed representative of such behavior may be transmitted to the social networking services for publication. Accordingly in response to the feed, information pertaining to the user, the platform, the selected media, and the service providing the media may be presented on one or more pages provided by the social networking service. By embedding special tags in the feed that are compliant with protocols and methods that are supported by an API exposed by a server in the social networking service, the data from the feed can be displayed on the pages with the same look and feel and user experience as native social networking content.

### CROSS-REFERENCE TO RELATED APPLICATIONS

This application claims benefit of priority of U.S. Provisional Patent Application No. 61/441,880, filed Feb. 11, 2011, entitled “Social Networking Feedback via Second Display Selections”, owned by the assignee of the present invention and herein incorporated by reference in its entirety.

### BACKGROUND

While satisfactory in many applications, browsing on current IPTV systems currently tends to be an isolated, single user experience. Although there are ways to add friends and share assets, this experience is only limited to current IPTV owners. There is no existing way to publicize this information to non-IPTV owners so that knowledge of such products and such technology exists in the market. Also, in this highly connected world, it would be generally desirable to have multiple ways to share assets as some ways may be more popular with different users than others.

### SUMMARY

Systems and methods are disclosed for creating and employing software to handle the browsing, selection, and playback of media, such as video, and other content and assets from external sources or services in web browsers that, in addition to or instead of playing the media in the web browser, use principles and protocols of a “second display” to instruct a content playback platform to play the selected media, e.g., on a platform that is optimized for media playback, such as an IPTV or other large television screen and/or on a home theater audio system. In some implementations, the software can be in the form of a browser plug-in or it can be in the form of a web application (“web app”) that the browser is configured to use to support the browsing, selection, and facilitation of playback of media on the optimized platform. The software can execute locally or alternatively be implemented using a cloud computing paradigm in whole or part (i.e., in combination with local execution) in which some portion of application code execute remotely on the cloud. In such an implementation, the second display can download code and/or objects, stream code and/or objects from a remote server (in some instances in real time or near real time), call remotely executed procedures and the like, and/or partially download code for local execution while streaming other portions of code and executing remote procedures in combination therewith. Second display applications written in native code may also be employed. Data pertaining to the user's behavior in browsing, selecting, and playing media, from particular sources on a particular platform, is tracked (with the user's permission) so that a feed representative of such behavior may be transmitted to one or more social networking services for publication. The publication may implemented, for example, in substantially real time (or near real time) on a per-user basis, or alternatively using a queue or bulk-based method in which publication to the social networking services is implemented for multiple users in non-real time. Tracked results may thus be published later in time to social networking services in cases, for example, where a local connection to the Internet is unavailable. Responsively to the feed, information pertaining to the user, the platform, the selected media, and the service providing the media may be presented on one or more pages provided by the social networking service. By embedding special tags in the feed that are compliant with protocols and methods that are supported by an API (application programming interface) exposed by a server in the social networking service, the data from the feed can be displayed on the pages with the same look and feel and user experience as native social networking content.

To accomplish the above, software is employed that is installed to handle media playback. This software may have the ability to play the media in the browser, like traditional media handling software, in addition to the ability to control consumer electronics devices to enable the same to play the media. In other implementations, software may specify the network location of selected media to the content playback device. The content playback devices, e.g., consumer electronics devices, may be caused to be the source of the request for a content item from a service provider, e.g., by providing the content item URL or URI to the content playback device from the second display for a subsequent request to a service provider.

To redirect content or to control content playback device settings, a group of users may exploit individual “second displays” to control settings, view, browse, and navigate content or data service offerings, by service providers, e.g., Internet network services, on behalf of a content playback device, e.g., IPTV, the same having authenticated credentials for playback of such content, and then arrange for a selected content item or items to be played back on the content playback device.

The second displays serve as an additional control for the IPTV, but generally do not require additional investment by the user because the same make use of a device, e.g., a smartphone, laptop computer, tablet computer, a desktop, an Internet appliance, etc., which most users would already have in their possession. Such a second display is a perfect complement to an IPTV because of the second display's strength in supported languages and character font sets, data entry, processing power, and user experience in content management. The application running on the second display may be a web application (scripting or non-scripting), a native application, a Java application, or any other sort of application that may work with a content playback device. For example, the ASP/NET framework with RPC can be employed to write the second display application. Where the web application running on the second display is written in HTML or HTML with Javascript, the same may be loaded by any device with a browser, and so the same is not limited to only a small set of compatible devices or expensive remote controls.

Communications with service providers may take place through a proxy server, and the proxy server presents to service providers the authentication credentials of the content playback device, so that the second displays appear to the service providers as an authenticated content playback device.

The second displays may include any device that can run an application that communicates with a content playback device, including, but not limited to, personal computers, laptop computers, notebook computers, netbook computers, handheld computers, personal digital assistants, mobile phones, smart phones, tablet computers, hand-held gaming devices, gaming consoles, and also on devices specifically designed for these purposes, in which case the special device would include at least a processor and sufficient resources and networking capability to run the web application.

The content playback device can take many forms, and multiple content playback devices can be coupled to and selected within a given local network. Exemplary content playback devices may include IPTVs, DTVs, digital audio systems, or more traditional video and audio systems that have been appropriately configured for connectivity. In video systems, the content playback device includes a processor controlling a video display to render content thereon.

In a general method, a user employing a second display has a user account with a source or clearinghouse of services. Here, the source or clearinghouse is represented as a user account on a management server, but it should be understood that the user account may be with a service provider directly. In any event, this account has information stored thereon related to what content playback devices are associated with the account. When a user logs on, they may see this list of content playback devices and may choose a particular content playback device. If there is only one content playback device on the network, or if the user is browsing in a way that the content playback device identity is not needed, then this step may be omitted.

Once a content playback device has been chosen, a list of services may be displayed (if more than one is available). The list of services may be customized to those that have content playable on the chosen content playback device, or all available content may be displayed, in which case, in certain implementations, a notation may be displayed adjacent the content item as to whether it is playable on the selected device. Where no content playback device has been selected, all available content may be displayed. If no content playback device has been selected, but the user account includes stored information about which content playback devices are available, then all content may be displayed, a subset of all content may be displayed based on the known content playback devices associated with the account, or notations may be presented about which content playback devices can play which content, or a combination of these. In some cases, a content service provider may require a content playback device to be chosen. In other cases, no content playback device need be chosen and the user may simply choose and queue content for later playback by a content playback device to-be-determined at a later time.

Assuming multiple services are available, the user then selects a service to browse. The service presents a list of available content items as noted above. The presentation may be in any number of forms, including by category, or in any other form of organization. The proxy server presents an authentication credential of the content playback device to the content server. In some cases, service provider credentials for accessing the various services may be stored in the account, and presented by the proxy server or management server to the content server when needed.

Individual services may employ their own DRM schemes which the current system may then incorporate. For example, if a video content service provider only allows a certain predetermined number of devices on which their content may be played back, then this rule will be enforced or duplicated within the current system and method. Moreover, changes to such service provider parameters may be periodically polled for by the proxy server and/or management server, or the same may be polled for at the next login of the service. In other words, upon login, the system and method may poll for and receive a token associated with the given service provider, the token providing information to the system about the user account with the content service provider.

The system and method may include a management server which, along with the content playback device, communicates with at least one content server such that the content server provides content items for presentation or access of the content item at the content playback device. The system and method may further include a proxy server communicating with the management server and the second displays. In some cases, the proxy server may be merged with the management server, or in other cases a separate proxy server may be provided for each content server or service provider.

A proxy server is further provided which includes at least one processor and at least one network interface communicating with the processor to establish communication between the processor and a wide area network. At least one computer-readable storage medium is accessible to the processor and bears logic causing the processor to receive login information from a second display. Responsive to a determination that the login information is correct, the server sends to the second display a local IP address of the content playback device associated with the login information. The proxy server receives from the second display information about the content playback device requesting a list of services available to the content playback device from at least one content server of a service provider and sends a request for the list of services to a management server. The proxy server receives from the management server the list and sends it to the second display for presentation of information on a video display thereof. The proxy server receives from the second display a request for a content item and, responsive to the request of the content item, requests a service login of the content server. The proxy server receives back from the content server a list of items, assets, categories or services and sends the list to the second display. In this way, the list can be presented on a video display of the second display so that a user can navigate to enter a selection to command the content playback device to play the selection.

In one aspect of the present systems and methods, an application which facilitates browsing and content selection is instantiated on the second display and a browsing session is established between the second display and a content source using the application. A content item identifier is loaded into the application and the content item is played back on a content playback device. Data associated with the browsing and playback is tracked and the data is populated into a feed which is transmitted to at least one social networking service. The browsing session may be associated with a user account and the user may be given a choice to opt in or opt out of the tracking. The feed may include tags that are compliant with an API exposed by the social networking service and the feed may further contain data pertaining to one of the user, the content item source, or the content playback device. The connection between the content playback device and second device may be wireless where a wireless connection scheme may include one of WiFi, 802.11, 802.15, or 802.16. The feed may be further personalized on a per-user basis and adapted for publication in substantially real time or alternatively be representative of a plurality of users and be further adapted for publication in bulk in substantially non-real time.

In another aspect of the present systems and methods, a second display includes a display module that provides a user interface and is configured to display a content item or receive a content item URL/URI. The second display further includes an asset browsing and selection tracking module for tracking displayed content items and content items that are selected for playback on the content playback device. The second display further includes a network communications module for coupling the second display to a local network or to a content playback device and for passing information tracked by the asset browsing and selection tracking module to be used in a feed to a social networking service. The second display may further include a browsing module for browsing content items that may be implemented in one of HTML, Javascript, or a native code using at least one of local execution, cloud-computing paradigm, or combination thereof, or alternatively, the browsing module may be a web-browsing module.

In another aspect of the present systems and methods, a system for publishing information on a social network may include a processor and memories bearing computer readable instructions, one of which is capable of loading an application into a browser, the application being configured for browsing one or more content items from various ones of a plurality of content providers, another of which is capable of receiving information about a content item, another of which is capable of causing a content item, chosen on a second display, to be played back on a content playback device, and another of which is capable of tracking the browsing and playing back, the tracking generating data for populating a feed usable by a social networking service to publish the data. The feed may include at least one of asset object, service object, platform object, or user object, each of the objects being configured for linking to an additional resource when invoked from the social networking service where the additional resource is provided by one or more pages supported by the social networking service or by one or more pages that are external to the social networking service. The feed may be populated in an IPTV domain and comprise at least one asset and associated metadata where the metadata incorporating tags that comply with an API exposed by the social networking service. The feed may further include advertising that is responsive to a user profile of a social networking service viewer.

In another aspect of the present systems and methods a method for providing a feed from an IPTV domain to a social networking site where the IPTV domain includes a content playback platform, second display operable by a user and management server infrastructure includes tracking the user's behaviors at the second display when browsing and selecting an asset for playback on the content playback device where the asset is provided from a service to which the IPTV domain is coupled over a network. The feed is populated with a data object where the data object represents at least one of the asset, the service, the platform, or the user. The feed is configured for interoperability with one or more pages supported by the social networking site so that the data object is selectable by a viewer of the site. The feed may be published to the social networking site from the management server infrastructure. The publishing may be performed via interaction with an API exposed by the social networking site so that the feed is incorporated into the one or more pages as native social networking content. One or more of the pages supported by the social networking site can implement native social networking features including posting a comment, link, or content item. An interface may be exposed to the user to enable the user to consent to the publishing of the feed to the social networking site.

Advantages of certain embodiments of the invention may include one or more of the following. Ways are provided to publish data about users in the form of a feed to social networking services from the IPTV domain. Feeds can be personalized to different users of the IPTV system and/or tailored to viewers of the social networking service. Extending the IPTV domain into popular social networking services can broaden the appeal of IPTV and significantly enhance the IPTV user experience.

Other advantages will be apparent from the description that follows, including the figures and claims.

### BRIEF DESCRIPTION OF THE DRAWINGS

Like reference numerals denote like elements throughout.

FIG. 1 is a block diagram of an exemplary system in accordance with one aspect of the present principles.

FIG. 2 is a block diagram of another exemplary system in accordance with one aspect of the present principles.

FIG. 3 is a sequence diagram illustrating a system and method according to one aspect of the present principles.

FIG. 4 shows data objects that may be implemented in one or more pages provided by a social networking service.

FIG. 5 is a flowchart illustrating an exemplary method according to one aspect of the present principles.

FIG. 6 is a block diagram of an exemplary second display system in accordance with another aspect of the present principles.

FIG. 7 is a block diagram of another exemplary second display system in accordance with yet another aspect of the present principles.

FIG. 8 illustrates an exemplary computing device, e.g., that of the disclosed second display, proxy server, management server, content server, or social network server.

### DETAILED DESCRIPTION

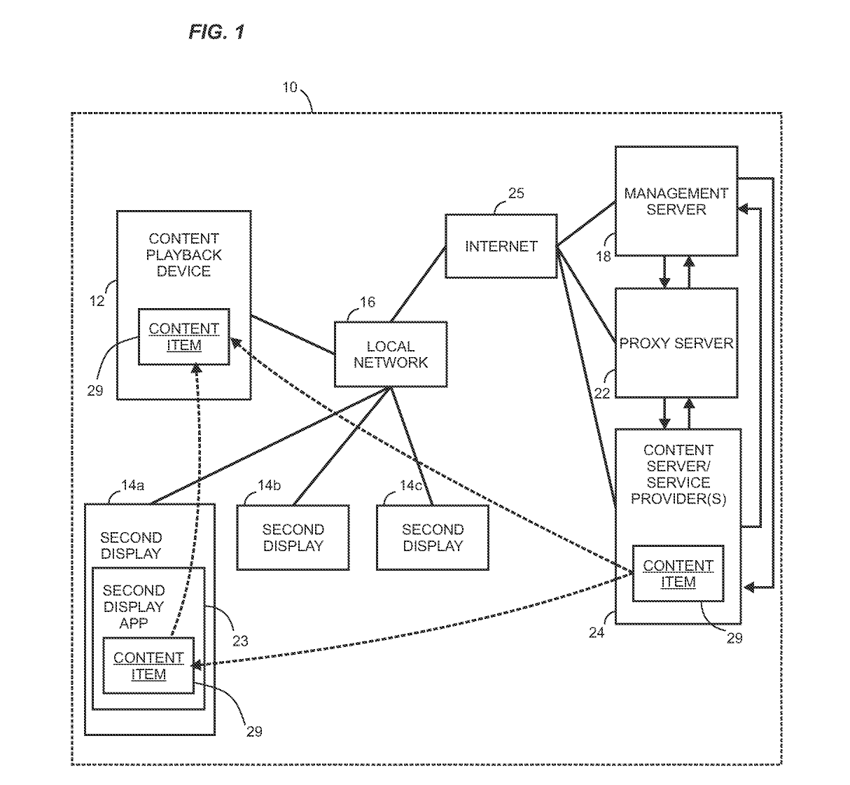

Referring initially to FIG. 1, a system 10 is shown including a content playback device 12 coupled to a local network 16, which may be wired, wireless, or a combination of both. Also coupled to the local network 16 are one or more second displays 14a-14c, an exemplary one of which is termed herein second display 14i. A number of servers may be accessed by the content playback device 12 and the second display 14i through the local network 16 and the Internet 25, including a management server 18, a proxy server 22, and one or more content servers 24 corresponding to service providers. It is noted that the Internet 25 is optionally utilized as there are usage scenarios in which the system 10 can be implemented so that the various features and functionalities provided by the management server 18, proxy server 22, and content servers 24 can be instantiated locally in either the local network, the second display 14i, or playback device 12 or in various sub-combinations therein. For example, various types of closed-circuit network or in-home networks can be utilized in whole or part to implement portions or all of the system 10.

A content item 29 may be stored on a content server 24 and the same may be viewed by a second display 14a. In particular, the content item 29 may be viewed in a second display application 23 that typically executes HTML and/or Javascript code (termed a “web application” or “web app”) that runs in a browser of the second display. While a web application is discussed here, one of ordinary skill in the art will recognize that non-web applications are also encompassed by the current principles, including those employing native code. The user of the second display 14a can then direct that the content item be displayed in the content playback device 12. The code utilized to instantiate the second display application 23 can be executed locally or by implementing a partial or full cloud-computing paradigm in which various combinations of locally executed code, downloaded code and objects, and/or streaming code and objects (including for example, that which executes in real time or near real time), are supported as may be needed to facilitate the functionalities of the second display as described herein.

The content playback device 12 may obtain the content item 29 for playback in a number of ways. Generally, the content playback device 12 receives the content item directly from the service provider (or an intermediary source). For this type of transmission, the second display 14a may send a signal to the service provider through the local network 16 and/or Internet 25 to the service provider. For example, where the second display application is a web application, the same may include Javascript in HTML that directly passes the desired URL/URI onto the content playback device. If necessary, the proxy server 22 may be employed, although in many cases content items 29 suitable for viewing in the second display application 23 may be obtained directly from the service provider. Many of these include DRM-free content or other freely-distributable content. In any case, other details about methods by which a second display may request that a content item appear on a content playback device are described below. In some cases, the second display 14a may directly transmit the content item 29 to the content playback device 12. This direct transmission may be by way of a direct wired or wireless connection, such as via USB, WiFi, or the like. For such direct transmissions, the second display 14a may act to buffer the media stream constituting the content item 29 in some implementations.

The content playback device 12 may be, e.g., an IPTV, a digital TV, a digital sound system, a digital entertainment system, a digital video recorder, a video disc player, a combination of these, or any number of other electronic devices addressable by a user on the local network 16. For the sake of simplicity, in this specification, the content playback device 12 will occasionally be exemplified by an IPTV, in which case it will generally include a processor that controls a visual display and an audio renderer such as a sound processor and one or more speakers. The processor may access one or more computer-readable storage media such as but not limited to RAM (Random Access Memory) storage, e.g., a chip implementing dynamic random access memory (DRAM), flash memory, or disk-based storage. Software code implementing present logic executable by the content playback device 12 may also be stored on one of the memories shown to undertake present principles. The processor can receive user input signals from various input devices including a remote control device, a point-and-click device such as a mouse, a keypad, etc. A TV tuner may be provided in some implementations, particularly when the content playback device 12 is embodied by an IPTV, to receive TV signals from a source such as a set-top box, satellite receiver, cable head end, terrestrial TV signal antenna, etc. Signals from the tuner are then sent to the processor for presentation on the display and sound system. A network interface such as a wired or wireless modem communicates with the processor to provide connectivity to the Internet through the local network 16. It will be understood that communications between the content playback device 12 and the Internet 25, or between the second display 14i and the Internet, may also take place through means besides the local network 16. For example, the second display 14i may communicate with the content playback device 12 through a separate mobile network.

The one or more second displays 14a-14c each bear a processor and components necessary to operate a second display application, e.g., a web application. Other types of applications may also be employed, so long as the same are capable of arranging for a content item to be played back on a content playback device. In particular, the processor in the second display may access one or more computer-readable storage media such as but not limited to RAM-based storage, e.g., a chip implementing dynamic random access memory (DRAM), flash memory, or disk-based storage. Software code implementing present logic executable by the second display may also be stored on one of the memories shown to undertake present principles. Further, the second display 14i can receive user input signals from various input devices including a point-and-click device such as a mouse, a keypad, a touchscreen, a remote control, etc. A network interface such as a wired or wireless modem communicates with the processor to provide connectivity to wide area networks such as the Internet as noted above.

The servers 18, 22, and 24 have respective processors accessing respective non-transitory computer-readable storage media which may be, without limitation, disk-based and/or solid state storage. The servers communicate with a wide area network such as the Internet via respective network interfaces. The proxy server 22 may in some cases be combined with the management server 18, although in many cases it may be preferable to separate the servers to better accommodate server load. The servers may mutually communicate via the Internet 25. In some implementations, the servers may be located on the same local network, in which case they may communicate with each other through the local network without accessing the Internet 25. For example, in one exemplary implementation, the management server 18 and the proxy server 22 may be disposed in the same data center, so communication between the two may stay within the data center.

While an exemplary method of the system is described below, certain method steps especially pertinent to certain arrangements of the second display will be described here.

Responsive to the second display 14i sending a request to the proxy server 22 for an executable utility, the proxy server 22 returns the utility to each second display 14i. Running the utility causes the instantiation of an application. As noted, the implementation discussed here includes a web application, but it will be understood that other types of applications may also be employed as described above. The second display 14i, executing the web application, prompts a user to input to each second display 14i login information. The login information may be common or may differ between second displays. The proxy server 22, responsive to reception of correct login information from the content playback device 12, returns the local IP address of the content playback device 12 to the second display 14i, because the same has previously been registered to a user account in which such information is maintained. The proxy server 22 may also return a list of content playback devices on the local network, responsive to which the second display 14i may select one for content playback. In turn, each second display 14i uses the local content playback device address to access the content playback device 12 directly to request information about the content playback device 12, which information is returned from the content playback device 12 to the second display 14i such that the local address of the content playback device 12 need not be globally addressable. Each second display 14i may also select content for playback on different content playback devices. The second display 14i sends the information about the content playback device 12 to the proxy server 22, requesting a list of services available to the content playback device 12 from one or more service providers. The services may be dependent on the device characteristics of the content playback device 12 chosen. For example, if the chosen content playback device 12 is an IPTV, video services may be returned. If the chosen content playback device 12 is an audio system, audio services may be returned.

The proxy server 22 relays the request for a list of services to the management server 18, which returns the list to the proxy server 22, with the proxy server 22 in turn sending the list to the second display 14i for presentation of information on the second display 14i. Responsive to a user selection of an item on the list, the second display 14i sends a request for a software asset corresponding to the selected content item to the proxy server 22. The proxy server 22 requests a service login of the content server 24 providing the content, and the content server 24 provides to the proxy server 22 a list of content items, categories, or services (collectively termed as an “asset” or “assets”), and the proxy server 22 relays the list to the second display 14i, which is presented on the second display 14i so that the user can navigate to enter a selection. Responsive to the selection, the second display 14i sends a command to the content playback device 12 to access and play back the selection.

The command to play the local content item may be in a number of forms. The second display 14i may communicate to the proxy server 22 the request on behalf of the content playback device 12, and this request may be via the local network or via other means. Alternatively, the second display 14i may transmit a request to the content playback device 12 that it itself formulate the request, and this transmission may be by way of the local network, the Internet generally, or via other means such as other wired or wireless transmission schemes, including via USB, infrared, Bluetooth®, or any other schemes. If the second display 14i is configured to address the content playback device 12 at a nonlocal level, e.g., at the server level, then the second display 14i may be physically located virtually anywhere and still be able to queue content or to command the content playback device 12 to play content. In this case, however, server load would increase over the case where the second display and content playback device communicated directly or over a local network.

Certain method steps of an arrangement of the content playback device are described here. Using a network interface, the content playback device 12 can communicate with a management server 18 on the Internet and with one or more content servers 24, also on the Internet and communicating with the management server 18. The management server 18 receives and stores a local IP address of the content playback device 12. The content playback device 12 communicates with the management server 18 to arrange for content items from the content server 24, operated by a service provider, to be played back on the content playback device 12. In more detail, the content playback device 12 sends login information to the management server 18 which returns to the content playback device 12 a user token that must subsequently be presented by the content playback device 12 to the content server 24 to obtain content from the content server 24.

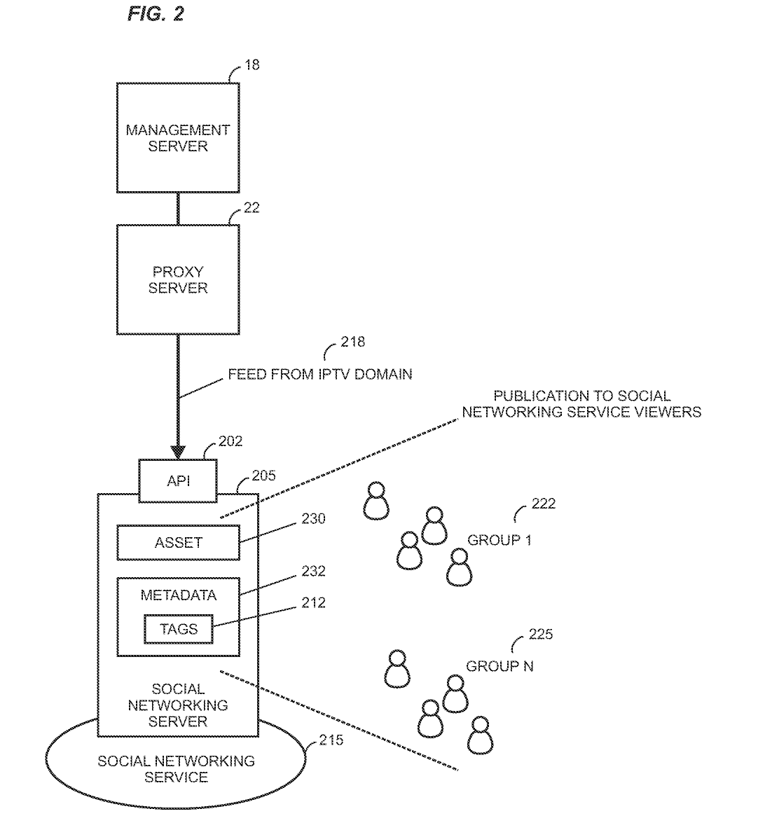

FIG. 2 shows an additional aspect of the present arrangement in which one or more servers 205 associated with a social networking service 215 are further operatively coupled to the servers 18 and 22 in the IPTV domain. The servers 18 and 22 are arranged to provide a feed 218 to the server 205 so that information from the IPTV domain may be published to viewers of the social networking service 215. The viewers may include individuals or various groups (representatively indicated by viewer groups 1 to N in FIG. 2 as indicated by reference numerals 222 and 225). In the exemplary arrangement shown in FIG. 2, the server 205 can typically expose an API (Application Programming Interface) 202 so that information from the feed 218, including an asset 230 and associated metadata 232, can be formatted and presented in a way that enables the feed 218 to be displayed in a similar manner to native content on the social networking service 215. Typically, the metadata 232 can incorporate the use of specific tags 212 that are consistent with protocols exposed by the API 202. In this way, assets from the IPTV domain can be conveniently and advantageously shared into the increasingly popular social media networks that can be implemented across a wide array of platforms and which can facilitate various communication and content-sharing services to the groups 222 and 225. For example, as described in more detail below, a user of systems according to the present principles may post IPTV assets and recommendations as feedback to a social networking service via the second display (e.g., the second display 14i in FIG. 1).

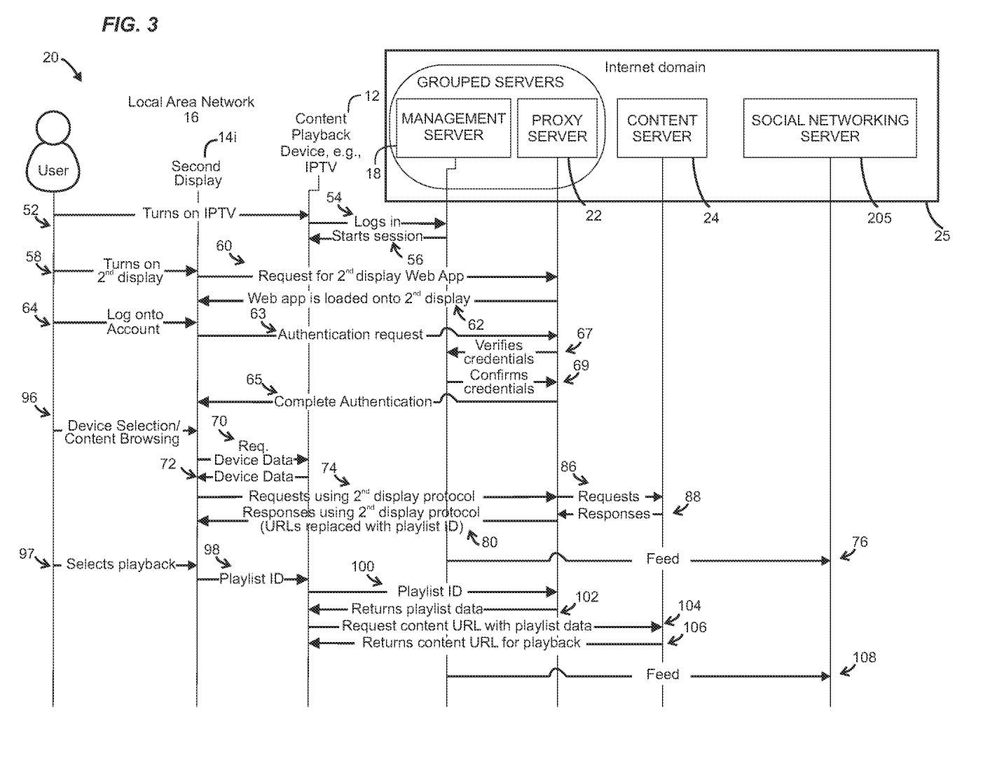

FIG. 3 is a sequence diagram illustrating an exemplary implementation of the system and method for enabling a user to employ a second display to browse content playback devices, service providers, and content items and select the same for playback by a content playback device and post certain assets and information to the social networking service 215 via the feed 218. FIG. 3 assumes that the user has already created an account with a management server and has affiliated one or more content playback devices with that account.

At state 52, a user turns on the content playback device 12. At state 54 the content playback device sends login information including, e.g., username and password, to the management server 18, which at state 56 returns to the content playback device a user token that may subsequently be presented by the content playback device to a content server 24 to obtain content from that server. The management server 18 in addition stores the local IP address of the content playback device 12.

At state 58, the user turns on the second display 14i and, e.g., instantiates a web browser session in which control may be exercised over the content playback device. A utility is executed on the second display 14i, at state 60, which sends a request to the proxy server 22, which returns in state 62 the web application, e.g., HTML with JavaScript that executes on a helper application, plug-in, or utility of the browser, for the second display to execute for browsing content items. The web application may make, e.g., asynchronous JavaScript and XML calls to the proxy server 22 and to the content playback device 12 to obtain information to control the content playback device 12.

With more specificity, at state 64, using the JavaScript received from the proxy server 22, the second display 14i prompts the user to input to the second display 14i the account login information, including, e.g., the same username and password that the content playback device provided to the management server 18 in state 54 during device registration. Of course, the account login information may differ as well. It will be appreciated that the servers 18, 22, and 24 communicate necessary account information between them as needed to realize the principles described here.

The proxy server 22 responds to a correct user name and password from the second display 14i in an authentication request state 63. The proxy server 22 verifies the user name and password with the management server 18 (states 67 and 69), creates and transmits a session token to the second display, obtains information about content playback devices affiliated with the user account, and completes the authentication in state 65. The proxy server 22 may return to each second display the information about all content playback devices 12 that are affiliated with the user account associated with the user name and password, including their local IP addresses which were stored by the management server 18 after login at 54 (and subsequently provided to the proxy server 22). In more detail, the proxy server 22 sends a token to the second display 14i, the token associated with a content playback device, and this token gets communicated in future transactions between the second display and the proxy server, so that the proxy server 22 knows what content playback device the content item is intended for. Each user with each second display may then choose a content playback device and browse the services and content options available through the services in state 96 and subsequent steps.

The second display 14i, using the local IP address returned as noted above, accesses the content playback device directly, in the sense of communicating through the local network. To select a particular content playback device, the second display 14i requests information about the content playback device 12 at state 70, including language information, digital rights management (DRM) information, etc., as desired, which information is returned from the content playback device to the second display 14i at state 72. Since the second display 14i knows the IP address of the content playback device 12 and consequently communicates directly with the content playback device 12, the second display 14i communicates using a local web address of the content playback device 12 that need not be globally addressable, and may so communicate as long as the second display 14i and content playback device 12 are on the same local network.

Each second display 14i may send the client information received at state 72 to the proxy server 22, requesting a list of services available to the content playback device 12, or that the content playback device 12 is entitled to, from one or more of the content servers 24. The proxy server 22 relays the request to the management server 18, which returns the requested service list to the proxy server 22. The proxy server 22 in turn sends the services list to the second display for presentation of available services on, e.g., a display of the second display. Each user browses the services and their content on the second display just as though it were the actual content playback device.

The user's browsing behavior may optionally be published to the social networking service 215 (FIG. 2) at state 76. In many cases, this optional feature can be implemented so that the user can opt in to (or in some implementations, opt out of) having the system 10 (FIG. 1) automatically publish the user's browsing behavior or a subset therein. The management server 18 (alone or in combination with the proxy server 22) can monitor the user's logins to various services exposed by the content server 24 and provide that information as an asset and/or related information (e.g., metadata) to the social networking server 205. For example, the user might log in to a movie service to browse the latest movies available on-demand. In such case, for example, the feed 218 (FIG. 2) could consist of a service login history, the movies' titles or genres browsed by the user, and related metadata. The social networking service could then, in turn, make information from the feed 218 available to the certain ones of the viewers 222 and 225 (FIG. 2). For example, friends of a user named John on the social networking service 215 might be informed with an alert or post stating that “John checked out Service Y for the latest action movies to watch on his IPTV at 4:15 pm on Tuesday!” In this example, it may be possible that a content provider, such as a movie studio, supply the information and other content-specific data that can be incorporated into the feed 218.

Continuing with the description of the sequence diagram in FIG. 3, the user can input, using, e.g., a second display input device, a selection of a service on the list that was returned to the second display. In response, the second display, at state 74, sends a request for the corresponding service to the proxy server 22 along with the service token that the second display may have received from the content server 24 via the management server 18.

Responsive to the request, the proxy server 22 requests a service login at state 86 of the content server 24 providing the selected service. At state 88, the content server 24 provides to the proxy server 22 a list of content items, assets, categories or services, as the case may be, for the particular content server 24. If desired, the proxy server 22 may also request of the content server 24 a list of options, and the list may be returned in, e.g., extended markup language (XML) format to the proxy server 22 which relays the content items, assets, categories, services, etc. available for selection to the second display at the state 80.

The content available for selection is presented on the second display so that the user can navigate the display to enter a selection in state 97. Responsive to the selection, the second display, at state 98, sends a command to the content playback device 12 to play the selection, and in particular sends a playlist id or reference identifier indicating the selection. At state 100, the content playback device 12, using its authentication credentials, sends the playlist id or reference identifier to the proxy server 22, which returns the required playlist data in state 102. The content playback device 12 can then request the content URL/URI with the playlist data in state 104, which may be responded to with a return of the content URL for playback of the content item on the content playback device 12 in state 106.

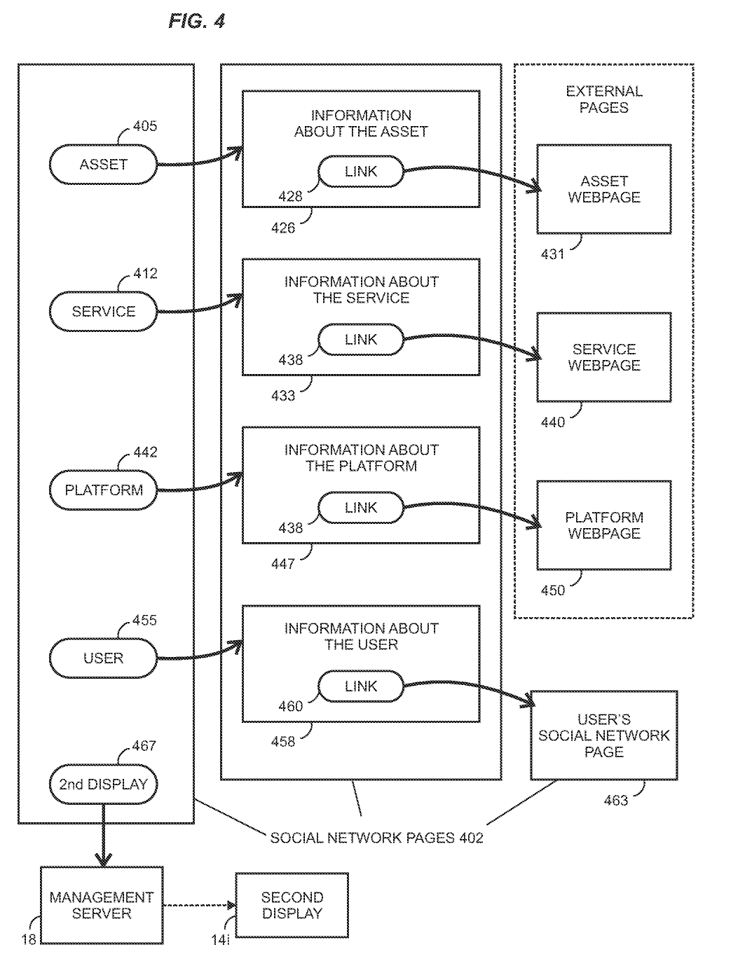

As states 97 through 106 are implemented and the system 10 (FIG. 1) is preparing an asset for playback on the content playback device 12, the management server 18 (alone or in combination with the proxy server 22) can prepare and send the feed 218 (FIG. 2) to the social networking server 205 so that the relevant asset and related information (e.g., metadata) may be published by the social networking service 215 at state 108. As shown in FIG. 4, the feed data may be configured using the special tags 212 that are recognized by the API exposed by the social networking service so that, for example, information about the asset, the service, platform, and user are published on one or more pages (collectively indicated by reference numeral 402) of the social networking site in a similar manner as native content. Exemplary data objects included in the feed representing published information are respectively indicated by reference numerals 405, 412, 442, 455 and 467 in FIG. 4.

In some implementations, the pages 402 can also include native social networking content and/or features and functionalities. For example, support may be provided for the social network service viewers to post comments, links, content items, assets, and the like to the pages 402 to supplement the data objects included in the feed 218 from the IPTV domain. In other implementations, the supplemental data can be provided as feedback to the user whose browsing or selection behavior prompted the feed. For example, comments from social networking viewers (who could be friends of the user, for example) regarding the asset may be provided to the user's second display as the asset plays back on the user's IPTV. The management server may be configured to expose a form on the second display which may be used by the user to post comments on the asset to the social networking service 215.

The published information may typically be implemented using HTML code and links so that the social networking network viewer (e.g., viewers 222 and 225 in FIG. 2) can click on an item on a page to get additional information. For example, if the asset object 405 is associated with a particular movie, the information 426 could include a cast listing, MPAA (Motion Picture Association of America) rating, run time, genre, plot synopsis, critiques/reviews, and the like. The information 426 may further include additional links to other internal pages supported by the social networking service, or to external pages (i.e., pages that are hosted by servers other than the social networking server). For example, clicking on link 428 in the asset information page could take the viewer to the asset's web page 431 (e.g., a page published by the movie studio pertaining to the particular movie in the example above). In a similar manner, clicking on the service object 412 on the social networking page can enable the viewers to learn details about the service offering available to the IPTV in the system 10 in FIG. 1 that is used to deliver the selected asset to the IPTV user. For example, the service 412 might be IPTV video-on-demand and information 433 could include a listing of the available IPTV titles (e.g., movies, television shows, music, games, documentaries, specials, etc.), and associated descriptions, pricing when applicable, dates of availability, and the like. The information 433 may also include a link 438 that, when clicked, takes the viewer to the service's external webpage 440.

If a viewer clicks on the platform object 442, information 447 about the IPTV platform may be made available to the social networking service viewers such as various features, functions, advantages, use cases, tips for getting the most out of the platform, and the like. In some instances, the information 447 may identify the specific manufacturer and model number of the user's IPTV. Advertising content about the platform (or other platforms) may also be included in the information 447 in some cases. The advertising may be of general interest to social networking service viewers, or be personalized in instances when a viewer is also an IPTV user that is serviced by the infrastructure associated with the management server 18 (FIG. 1) in the IPTV domain. In this latter case, the management server 18 would typically have knowledge of that viewer's IPTV platform so the advertising could be more specific, for example, and may include upgrade opportunities to the viewer's current IPTV platform, complementary hardware or accessory information, and the like. The information 447 can further include a link 439 to the IPTV's platform external webpage 450.

When the social networking service viewer clicks on the user object 455, information 458 about the user is shared. Such information is typically information that the user has chosen to make public such as user name, profile, and the like. The information 458 can include a link 460 to the user's social networking page 463 or a link to an external webpage (not shown). In some implementations of the present arrangement, advertising can be included in the feed 218 which is directed to users/viewers based on such profile.

A second display object 467 is also supported on the social networking page which, when clicked by a viewer, may cause the management server 18 to issue commands to responsively open the viewer's own second display app and to focus on the asset 405 to thus enable playback of the asset on the viewer's own IPTV. Alternatively, the viewer may be directed to another website associated with the management server infrastructure but which is more content related and not necessarily including functionality related to controlling an IPTV. In some implementations of the present arrangement, a separate discrete second display object is not utilized and its functionality may be incorporated into the asset object 405. In this case, clicking on the asset 405 will enable access to the asset via the social networking page viewer's own second display so that playback of the asset may be implemented on the viewer's own IPTV.

It is noted that states 76 and 108 in FIG. 3 can be configured to be automatically implemented (typically when selected by the user to be performed automatically), or may be alternatively implemented in response to an affirmative and explicit action by the user. For example, the user may desire not to have his or her asset browsing and selection activities to be automatically published to the social networking service and instead choose to publish the asset on a case by case basis where an explicit affirmation from the user is needed before an asset will be shared. In both implementations, the appropriate user interface can be provided on the second display to enable automated publishing preferences and parental controls to be set and/or explicit sharing actions to be performed. For example, in an IPTV household, some younger users may not be allowed to enable automatic publishing and might further be restricted in affirmative sharing as to the types of information that can shared to the social networking service, the times when information may be shared, and the like. In addition to supporting different preferences and/or restrictions on a per-user basis, the present arrangement may also be configured to enable the feed to be customized on a per-user basis and/or per-social networking viewer basis so that different feeds can go to different viewers depending on the particular IPTV user, user-selected preferences, explicit or affirmative user actions, or combinations thereof.

Variations of the present system and method are now described.

If the content playback device were already playing content, the new content commanded to be played by the second display may be placed in a queue in the content playback device and played when the current content completes. In any case, once the content has been commanded to be played, the user may continue to browse the second display for other content, to play or to add to the queue. Other users may employ their own second displays to do the same. A user may also desire to switch devices and resume playback on a different device by, e.g., navigating to a “recently viewed” list and selecting the last video played after switching control to the desired device.

The above description has been for the case where the proxy server 22 is employed to hide the content source, e.g., a content URL/URI, from the second display 14i. That is, the proxy server 22 provides an API for the second display to use so that the content and/or content URL/URI cannot be accessed directly, i.e., the details of the management server transactions to access the services remain desiredly unknown. In many cases, the second display 14i may have stored thereon little or nothing of the content playback device 12 details. In some cases, however, the URL/URI may be directly provided from the proxy server 22 or the proxy server 22 may even be bypassed, e.g., in cases where the content item is intended for free distribution, e.g., movie trailers or the like. Similarly, while the above description has focused on content item playback on content playback device 12, certain content items, e.g., those which are intended for free distribution, may be played back on the second display 14i itself, if the same has been appropriately configured, e.g., via using the plug-in or helper application described.

In the case where multiple second displays request content to be played at or near the same time, a simple rule such as the first-in-time may prevail. Alternatively, a priority scheme may be configured, such that certain second displays take precedence over other second displays.

Note further that the control device may command the content playback device to play content by sending to the content playback device over the local network commands coded as if they were sent from an infrared remote control, specifically for example the commands may be in the Sony Infrared Remote Control System (SIRCS) protocol.

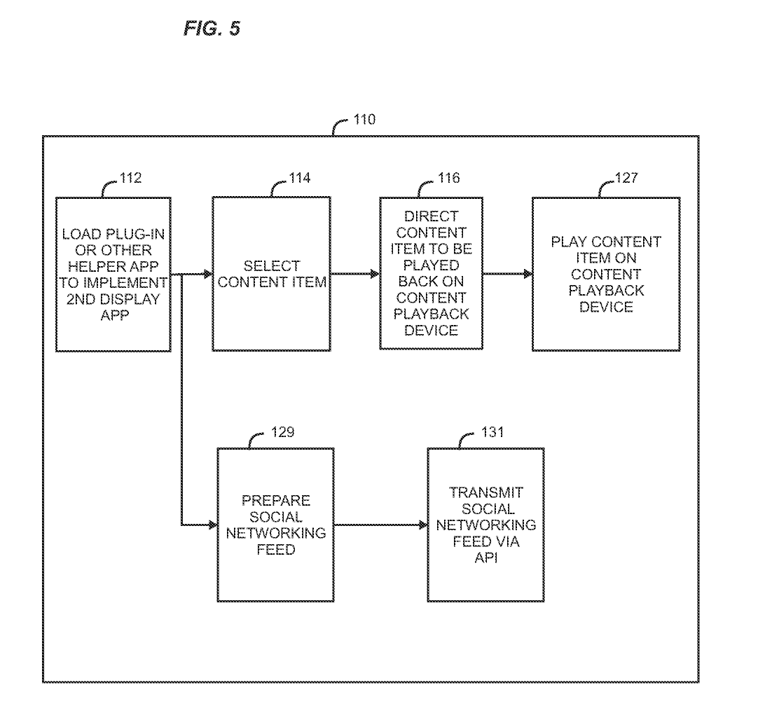

FIG. 5 illustrates one exemplary method 110 by which software may be employed to handle playback of media, especially video, in web browsers that, in addition to or instead of playing the media in the web browser, will use the second display protocol to instruct a separate display device, such as a content playback device, to play the media. In addition, as the playback response is being prepared, software may be employed to prepare the feed 218 to the social networking service 215 via the API 202 to the server 205 (FIG. 2).

One context of the system and method may be that a user opens a browser window and requests a content item to be played back, although variations will be seen by one of ordinary skill in the art given this teaching. A first step is that the step of requesting a content item loads a second display application (step 112). Steps may then occur such as a selection of a content playback device and selection of a service provider (not shown). A next step is that a content item is selected at the second display application (step 114). A next step is that the content item is directed to be played back on the content playback device (step 116). The content item may then be played back by the content playback device (step 127). As noted above, as content is readied for playback, the feed to the social networking service is prepared (step 129) and then transmitted to the social networking service 215 via the API 202 shown in FIG. 2 (step 131).

Aspects of various components are described below.

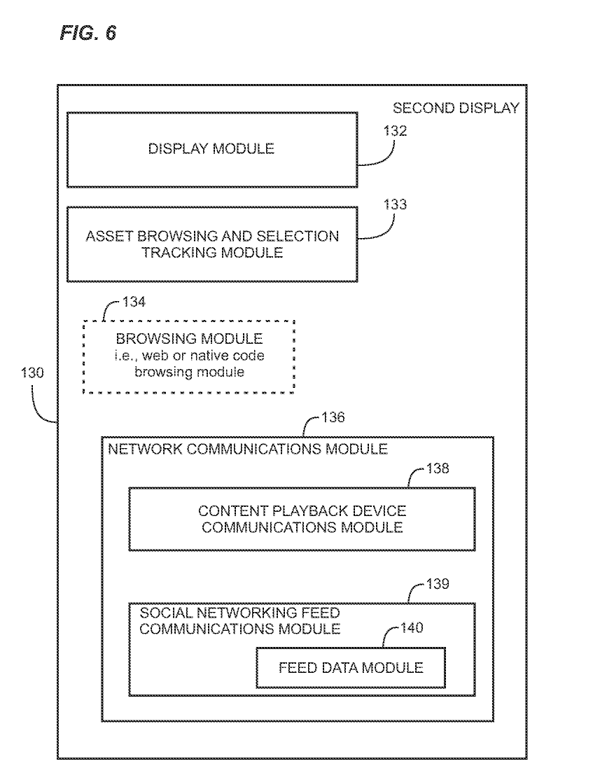

FIG. 6 illustrates one implementation of a second display 130. The second display 130 includes a display module 132 for use in, among other aspects, browsing lists and selecting items related to the content playback device. For example, a list of content playback devices accessible to the local network and/or addressable by the second display may be displayed using the display module 132, and the user may choose a content playback device from among them. In addition to choosing a content playback device, or instead of, a user may review a list of accessible service providers using the display module 132. For example, such service providers may include those offering video-on demand services for movies and other video content, or any number of other sites on which media and content may be browsed and selected. In one implementation, where a content playback device has been chosen, the results may be filtered based on the capability of the device to render the content. In another implementation, the display module 132 may display not just content accessible to the local network, but also content resident on the local network, such as content stored on a digital video recorder or Blu-ray® player.

The second display 130 includes an asset browsing and selection tracking module 133 that implements tracking of the user's browsing and selection of assets including, for example, content items, playback platform, services, providers, etc. The user's behavior regarding these assets is tracked so that the data can be collected for the feed to the social networking service.

Also within the second display 130 may be a browsing module 134 through which the above noted content items may be browsed in the case where the second display application is written in HTML and Javascript. The web-browsing module 134 may be implemented in a number of ways, including by executing application code written in HTML, Javascript, or the like. A web browsing module implemented in such a way allows the same to be implemented across many platforms, allowing any number of types of second displays to be employed. As noted above, second display applications written in native code may also be employed. Moreover, in some cases, special applications, e.g., helper applications, may be employed to communicate with particular proprietary or non-web-based technologies. The web-browsing module 134 may also include various plug-in modules to enable different content types to be played back in the browser itself. Such plug-ins may in some cases allow content items to be viewed in the second display, such as before their redirection to the content playback device. Where the second display application is non-web-based, and is written in, e.g., native code, the web-browsing module 134 may be replaced with a suitable other module allowing service and content selection or other such functionality.

The second display 130 also includes a module for network communications 136. The network communications module 136 allows the second display to communicate with the local network as well as, in some cases, specific devices directly. As part of the network communications module 136, a communications module 138 for communications with a content playback device is provided. The content playback device communications module 138 allows the second display to communicate with the content playback device either over the local network or directly (Internet communications may also be employed). Such direct communications may include various types of wired or wireless transmission schemes, including WiFi, USB, infrared, Bluetooth®, or the like.

The network communications module 136 further includes a social networking feed communications module 139. The social networking feed communications module 139 allows the second display to communicate with the management server and/or proxy server so that data resulting from the tracking of the user's asset browsing and selection behavior can be collected and sent as the feed to the social networking server. The social networking feed module 139 can be configured to store and/or buffer the data provided in the feed which is implemented, in this example, using a feed data module 140.

It is noted that the above modules may be implemented in hardware, non-transitory software, or a combination of the above. Typically, the same will be implemented within the context of a laptop computer, a tablet computer, a smart phone, or the like.

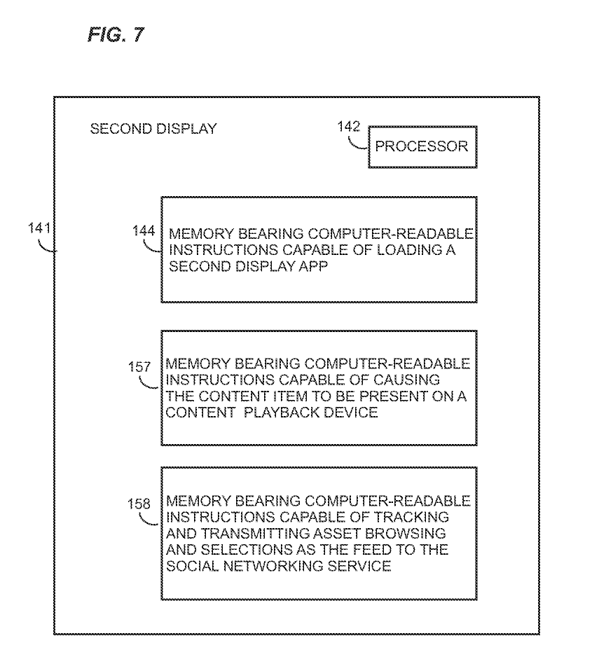

Referring to FIG. 7, another implementation of a second display 141 is illustrated. In this implementation, the second display 141 includes a processor 142. The second display 141 further includes memory 144 bearing computer readable instructions capable of loading a second display application.

The second display 141 may also include memory 157 bearing computer readable instructions capable of causing a content item to be present on a content playback device. With memory 157, the content item may be made present by downloading from a service provider, either directly or through a management or proxy server. In this regard, the request for the content item may be configured to be made from the content playback device or from the second display.

Alternatively, or in combination, the second display 141 may include memory 158 bearing computer readable instructions capable of tracking user behavior with regard to asset browsing and selection and facilitating the transmission of the feed to the social networking service, either directly or through the management or proxy server.

Systems and methods have been disclosed that allow improvement of the user experience of the IPTV without adding to the hardware costs of the unit. As disclosed above, software may be created and employed to handle the playback of media, especially video, in a content playback device by a second display. Data pertaining to the user's behavior in browsing, selecting, and playing media, from particular sources on a particular platform, is tracked (with the user's permission) so that a feed representative of such behavior may be transmitted to one or more social networking services for publication.

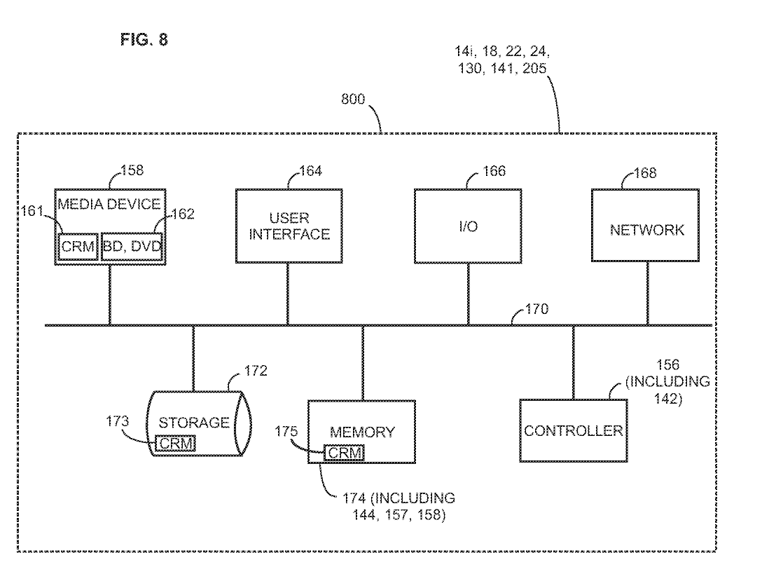

One implementation includes one or more programmable processors and corresponding computing system components to store and execute computer instructions, such as to execute the code that provides the second display or various server functionality, as well as for browsing. Referring to FIG. 8, a representation of such an exemplary computing device 800 for a second display 14i, proxy server 22, management server 18, content server 24, or social network server 205, is illustrated.

The computing device includes a controller 156, a memory 174, storage 172, a media device 158, a user interface 164, an input/output (I/O) interface 166, and a network interface 168. The components are interconnected by a common bus 170. Alternatively, different connection configurations can be used, such as a star pattern with the controller at the center.

The controller 156 includes a programmable processor and controls the operation of the computing device and its components. The controller 156 loads instructions from the memory 174 or an embedded controller memory (not shown) and executes these instructions to control the system. In its execution, the controller 156 may provide, for example, the second display 14i control of a content playback device system 12 as, in part, a software system. Alternatively, this service can be implemented as separate modular components in the controller 156 or the second display 14i.

Memory 174, which may include non-transitory computer-readable memory 175, stores data temporarily for use by the other components of the computing device 800 and the same may include memories 144, 157, and 158 as discussed above. In one implementation, memory 174 is implemented as RAM. In other implementations, memory 174 also includes long-term or permanent memory, such as flash memory and/or ROM.

Storage 172, which may include non-transitory computer-readable memory 173, stores data temporarily or long-term for use by other components of the computing device 800 such as for storing data used by the system. In one implementation, storage 172 is a hard disc drive or a solid state drive.

The media device 158, which may include non-transitory computer-readable memory 161, receives removable media and reads and/or writes data to the inserted media. In one implementation, the media device 158 is an optical disc drive or disc burner, e.g., a writable Blu-ray® disc drive 162.

The user interface 164 includes components for accepting user input, e.g., the user content selections, from the user of the computing device 800 and presenting information to the user. In one implementation, the user interface 164 includes a keyboard, a mouse, audio speakers, and a display. The controller 156 uses input from the user to adjust the operation of the computing device 800.

The I/O interface 166 includes one or more I/O ports to connect to corresponding I/O devices, such as external storage or supplemental devices, e.g., a printer or a PDA. In one implementation, the ports of the I/O interface 166 include ports such as: USB ports, PCMCIA ports, serial ports, and/or parallel ports. In another implementation, the I/O interface 166 includes a wireless interface for wireless communication with external devices. These I/O interfaces may be employed to connect to one or more content playback devices.

The network interface 168 allows connections with the local network and optionally with content playback device 12 and includes a wired and/or wireless network connection, such as an RJ-45 or Ethernet connection or “WiFi” interface (802.11). Numerous other types of network connections will be understood to be possible, including WiMax, 3G or 4G, 802.15 protocols, 802.16 protocols, satellite, Bluetooth®, or the like.

The computing device 800 may include additional hardware and software typical of such devices, e.g., power and operating systems, though these components are not specifically shown in the figure for simplicity. In other implementations, different configurations of the devices can be used, e.g., different bus or storage configurations or a multi-processor configuration.

Various illustrative implementations of the present invention have been described. However, one of ordinary skill in the art will recognize that additional implementations are also possible and within the scope of the present invention.

For example, while the application running on the second display has been disclosed in generic terms as a second display application, the same may be a web application, a native application, a Java application, or any other sort of application that may control at least in part a content playback device. Moreover, while several implementations of the invention include that the user select a particular content playback device for playback, in some implementations a user may browse content with no content playback device selected at all. In other implementations, a cache or cookie or other information may be employed to store information about content playback devices, so that no user choice is necessary. In another example, samples of content items may be obtained from content service providers, and these samples may be browsed freely without a user selection of a content playback device for playback. In another variation, a profile system may be employed that communicates content playback device information upon start-up according to a profile; e.g., a given content playback device may always be associated with and may authenticate itself with a given service provider. In this sense, a content playback device is still being chosen, but the choice does not require an affirmative step by the user. Use of any of these alternatives, or others, ensures that the content consumption of each content playback device is tracked. It further allows, as described, the proxy server to filter out content that the content playback device is incapable of playing. It is also noted that certain types of browsing may require no device at all, e.g., browsing shopping sites. Still, some level of customization may occur, e.g., by consideration of the origination location of the visiting second display's IP address.

Content items from any suitable source are contemplated, including but not limited to: networked, wireless, including 3G, 4G, and the like, local, e.g., from a local or shared drive or accessible via DLNA or accessible via a specialized network storage device, or accessible via removable media such as a media card or USB storage device, CD, DVD, or Blu-ray®. Content may also be accessed from a cell phone, portable media player, camera or camcorder, or other devices the second display may access. In addition, any suitable types of content items are contemplated, including but not limited to AC3, MP3, MPEG, etc. Any suitable format of content items is contemplated, including but not limited to m3u, ASX, ASX-XML, etc. Any suitable protection scheme is contemplated, including but not limited to DRM, etc. Any suitable protocol is contemplated, including but not limited to HTTP, HTTPS, etc. Any suitable playback method is contemplated, including but not limited to those varying in buffering limit, when to buffer, treating video playback differently from audio playback, and the like.

In addition, the above description was primarily directed to an implementation in which the local IP address of the second display was retrieved and stored on the server. However, other ways of discovering the second display are also possible. For example, device discovery is also possible using a broadcast method within the local network. Compatible devices that recognize the broadcast message will respond with their necessary credentials and information to indicate their compliance with the web application for the second display. In many cases, broadcasting methods are primarily directed to native applications, not web applications; however, a broadcasting library may be employed to allow the implementation within a web application. Such methods also apply to the discovery of content playback devices on the network.

While the above description has focused on implementations where a second display is coupled to a content playback device through a local network, it will be understood that the same will apply to any method by which the two may communicate, including 3G, 4G, and other such schemes.

Accordingly, the present invention is not limited to only those implementations described above.

1. A method of playing a content item on a content playback device using a second display, comprising:
i. instantiating an application on the second display;
ii. establishing a browsing session between a second display and a source of content using the application, the application facilitating browsing and selection of a content item by a user;
iii. loading an identifier of the content item in the application;
iv. causing the content item to play back in a content playback device;
v. tracking data associated with the browsing and playback;
vi. populating a feed with the tracked data; and
vii. transmitting the feed to at least one social networking service.

2. The method of claim 1, wherein the feed includes tags compliant with an API exposed by a server operated by the social networking service.

3. The method of claim 1, wherein the feed further includes data pertaining to the user.

4. The method of claim 1, wherein the feed further includes data pertaining to the source of the content item.

5. The method of claim 1, wherein the feed further includes data pertaining to the content playback device.

6. The method of claim 1, wherein a connection between the content playback platform and second display is wireless, and wherein a wireless transmission scheme includes a scheme selected from the group consisting of: WiFi, 802.11, 802.15, or 802.16.

7. The method of claim 1, wherein the feed is personalized on a per-user basis and is adapted for publication in substantially real time or wherein the feed is configured to be representative of a plurality of users and is further adapted for publication in bulk in substantially non-real time.

8. The method of claim 1, wherein the browsing session is associated with a user account.

9. The method of claim 7, including a further step of providing the user with a choice of opting in or opting out of the tracking.

10. The method of claim 7, further comprising:
i. transmitting to the second display a list of available service providers;
ii. receiving from the second display a selection of a first content item from one of the service providers;
iii. placing the first content item in a queue;
iv. receiving from the second display a selection of a second content item from another of the service providers; and
v. placing the second content item in a queue.

11. The method of claim 1, wherein the causing includes causing the content playback device to request the content item.

12. A non-transitory computer-readable medium, comprising instructions for causing a computing device to implement the method of claim 1.

13. A second display, comprising:
i. a display module, the display module providing a user interface and configured to display a content item or to receive a content item URL/URI;
ii. an asset browsing and selection tracking module for tracking displayed content items and content items that are selected for playback on the content playback device; and
iii. a network communications module, the network communications module for coupling the second display to a local network or to a content playback device and for passing information tracked by the asset browsing and selection tracking module to be used in a feed to a social networking service.

14. The second display of claim 13, further comprising a browsing module for browsing content items.

15. The second display of claim 14, wherein the browsing module is implemented in HTML, Javascript, or a native code using at least one of local execution, cloud-computing paradigm, or combination thereof.

16. The second display of claim 15, wherein the browsing module is a web-browsing module.

17. The second display of claim 13, wherein the passing is via a wireless communication scheme.

18. A system for publishing information on a social network, comprising:
i. a processor;
ii. memory bearing computer readable instructions capable of loading an application into a browser, the application being configured for browsing one or more content items from various ones of a plurality of content providers;
iii. memory bearing computer readable instructions capable of receiving information about a content item;
iv. memory bearing computer readable instructions capable of causing a content item, chosen on a second display, to be played back on a content playback device; and
v. memory bearing computer readable instructions capable of tracking the browsing and playing back, the tracking generating data for populating a feed usable by a social networking service to publish the data.

19. The system of claim 18, wherein the feed includes at least one of asset object, service object, platform object, or user object, each of the objects being configured for linking to an additional resource when invoked from the social networking service.

20. The system of claim 19, wherein the additional resource is provided by one or more pages supported by the social networking service.

21. The system of claim 19 in which the additional resource is supported by one or more pages that are external to the social networking service.

22. The system of claim 18, wherein the feed is populated in an IPTV domain.

23. The system of claim 18, wherein the feed comprises at least one asset and associated metadata, the metadata incorporating tags that comply with an API exposed by the social networking service.

24. The system of claim 23, wherein the asset is selectable and is instantiated on an IPTV associated with a viewer of the social networking service when so selected.

25. The system of claim 18, wherein the feed includes advertising that is responsive to a user profile of a social networking service viewer.

26. A method for providing a feed from an IPTV domain to a social networking site, the IPTV domain including a content playback platform, second display operable by a user and management server infrastructure, comprising:
i. tracking the user's behaviors at the second display when browsing and selecting an asset for playback on the content playback device, the asset being provided from a service to which the IPTV domain is coupled over a network;
ii. populating the feed with a data object, the data object representing at least one of the asset, the service, the platform, or the user;
iii. configuring the feed for interoperability with one or more pages supported by the social networking site so that the data object is selectable by a viewer of the site; and
iv. publishing the feed to the social networking site from the management server infrastructure.

27. The method of claim 26, wherein the publishing is performed via interaction with an API exposed by the social networking site so that the feed is incorporated into the one or more pages as native social networking content.

28. The method of claim 26, wherein the selecting of the data object by the viewer triggers provision of additional information from the feed.

29. The method of claim 26, wherein the data object represents a second display associated with the viewer and wherein selecting the data object enables an application to execute on the second display to thereby display information about the asset.

30. The method of claim 26 further comprising configuring the one or more pages to implement one or more native social networking features.

31. The method of claim 30, wherein the one or more native social networking features include one of posting a comment, link, or content item.

32. The method of claim 26, further comprising exposing an interface to enable the user to consent to the publishing of the feed to the social networking site.
